(19) United States
(12) Patent Application Publication
(10) Pub. No.: US 2015/0350428 A1
(43) Pub. Date: Dec. 3, 2015

(54) PUSHING WEB AND APPLICATION PAGES DURING VIDEO/AUDIO CALLS

(71) Applicant: CafeX Communications, Ltd., Cardiff (GB)

(72) Inventors: Kevin J. Glass, Cardiff (GB); David Jodoin, Boston, MA (US); David Watts, Cardiff (GB)

(21) Appl. No.: 14/723,603

(22) Filed: May 28, 2015

Related U.S. Application Data
(60) Provisional application No. 62/004,592, filed on May 29, 2014.

(51) Int. Cl. H04M 3/493; H04L 29/08

(52) U.S. Cl. CPC H04M 3/493; H04L 67/02; H04L 67/26

(57) ABSTRACT

A method and system for pushing web pages to a web client during a video/audio call. The method involves assigning a correlation ID to a web client to which a web page is served. The same correlation ID value is communicated by the web client to a VIVR/context web server computer. The VIVR/context web server computer is arranged to serve at least one web page to the web client. A voice/video call is established between the web client and a contact center agent computer responsive to a request from the web client. As part of initiating such call, the correlation ID is communicated to the contact center agent computer. Thereafter, during the voice/video call, at least one command is generated which causes the VIVR web server to serve at least one web page to the web client using the correlation ID.

### RELATED APPLICATIONS AND CLAIMS OF PRIORITY

This patent application claims the benefit of U.S. Provisional Patent Application No. 62/004,592 filed May 29, 2014, the disclosure of which is fully incorporated herein by reference.

### BACKGROUND OF THE INVENTION

1. Statement of the Technical Field

The inventive arrangements relate to computer systems and more particularly to computer infrastructure for managing and sharing data and media as between mobile/web applications and corporate contact center systems.

2. Description of the Related Art

Interactive voice response (IVR) systems are commonly used to facilitate a human interaction with an enterprise computer system by way of a telephone or mobile communication device. In such systems, customers interact with the host computer system using a telephone keypad or by speech recognition. These systems allow users to service their own interface needs without a human operator by following an IVR dialogue. The IVR dialogue is usually a pre-recorded or computer generated audio dialogue that is defined by an IVR tree. Conventional IVR systems as described herein allow users to interface with the host computer system by means of a series of simple interactions. These interactions usually involve the use of DTMF tones and/or voice recognition algorithms to determine user selections. Visual interactive voice response (visual IVR) systems are conceptually similar to conventional IVR systems, but are enhanced insofar as they also allow users to interact with the host computer through a series of visual menus. Visual IVR systems take the process to a higher level by allowing the user to make service selections through a menu displayed on a smart-phone or other type of mobile device with display capability. Because of their importance to the overall success of an enterprise, companies make substantial investments in their IVR systems to ensure that they provide for a pleasant user experience and cost-effective processing of user service needs.

In a conventional IVR system the customer or user places a call to a particular entity. When the call is received, the IVR system executes a series of automated scripts and then responds to simple user commands to satisfy the customer's service requirements. A visual IVR system works in a similar manner with the web application connecting into the IVR system to execute the relevant scripts. In many instances of either the IVR or VIVR interaction, the customer may determine that they need to speak with a human call center agent. Accordingly, the IVR system will receive certain user inputs in response to the IVR script and then establish the necessary call to a human agent in a contact center. Once a connection is made to the human agent in the contact center, use of the IVR system generally terminates with respect to that particular customer, who then continues dealing only with the human operator.

### SUMMARY OF THE INVENTION

Embodiments of the invention concern a method system for pushing web pages to a web client during a video/audio call. Briefly, the method involves assigning a correlation ID to a web client to which a web page is served. The same correlation ID value is communicated by the web client to a VIVR/context web server computer. The VIVR/context web server computer is arranged to serve at least one web page to the web client. A voice/video call is established between the web client and a contact center agent computer responsive to a request from the web client. As part of initiating such call, the correlation ID is communicated to the contact center agent computer. Thereafter, during the voice/video call, at least one command is generated which causes the VIVR web server to serve at least one web page to the web client. The particular web client to be served is identified to the VIVR web server by the contact center agent computer using the correlation ID.

### BRIEF DESCRIPTION OF THE DRAWINGS

Embodiments will be described with reference to the following drawing figures, in which like numerals represent like items throughout the figures, and in which:

FIG. 1 is a drawing that is useful for understanding an architecture of a visual IVR system.

FIG. 2 is a drawing that is useful for understanding a computer system for pushing web pages to a web client during a video/audio call.

FIG. 3 is a drawing that is useful for understanding a process by which web pages can be pushed to a web client during a video/audio call.

### DETAILED DESCRIPTION

The invention is described with reference to the attached figures. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operation are not shown in detail to avoid obscuring the invention. The invention is not limited by the illustrated ordering of acts or events, as some acts may occur in different orders and/or concurrently with other acts or events. Furthermore, not all illustrated acts or events are required to implement a methodology in accordance with the invention.

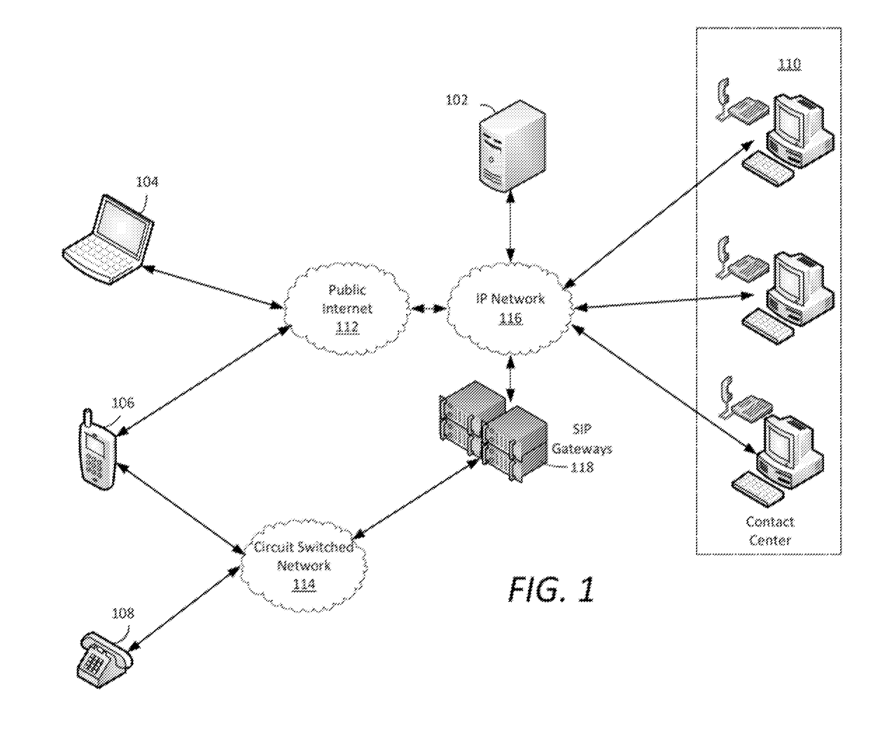

Visual IVR systems are used today to replace existing IVR systems to either fast-track the process of identifying the appropriate contact center agent or removing the need for contact center agent altogether. A simplified architecture of an IVR system shown in FIG. 1 includes a plurality of end-user devices such as computer 104, smart-phone 106 and conventional telephone 108. The end user devices communicate with an IVR server 102 (which may be a visual IVR server) through IP network 116. Communications with the IP network 116 are facilitated by using public internet 112, circuit switched network 114, and/or SIP gateways 118. End users can establish contact with contact agents (not shown) in a contact center 110 by interacting with an IVR dialog implemented by IVR server 102. Communications with the IVR server are implemented through IP network 116. Suitable telephone equipment and workstations are provided at the contact center to facilitate communications with contact agents after customers or end-users have made the necessary responses to the IVR dialog. These IVR systems work well but also have certain limitations. For example, once a customer or user is connected into the contact center 110, there is no ability to utilize corporate investment in the IVR scripts by delivering those scripts after the call has been connected. To solve this problem, the inventive arrangements comprise a dynamic and flexible end-to-end infrastructure for managing and sharing data and media between mobile/web applications and corporate contact center systems. A seamless and integrated user experience is provided by a combination of client and server side software, and a flexible rules-driven context server. The resulting system is highly flexible and offers numerous benefits. For example, the system can be used to facilitate the delivery of visual IVR or web pages during a call between a customer and a contact center agent.

The inventive arrangements are described in detail below. However, one notable aspect of the system involves the use of a correlation identifier or correlation ID. The correlation ID is essentially a data value that is assigned to both the call and web/mobile application. Once assigned, the correlation ID serves as a common session identifier to track a user session as the user transitions through the various phases of interaction with the host enterprise. The provision and use of this common session identifier provides numerous advantages. As explained in more detail below, the correlation ID can allow the contact center agent to trigger during a call, the delivery (to the end-user client) of visual instances of the corporate IVR “scripts” or web pages. The correlation ID can also facilitate the sharing of contact center collateral data with the end user. The correlation ID further ensures that the end-user client associated with the particular call receives the necessary trigger for additional input and requests the appropriate visual IVR script from a context server. The context server can then access the corporate IVR system to re-use the scripts which have been developed to deliver traditional IVR interactions. The user will interact with the new web/application pages to enter appropriate information or responses. When the user information is then communicated to the context server, the context server can further use the correlation ID to ensure delivery of the captured information to the appropriate contact center agent.

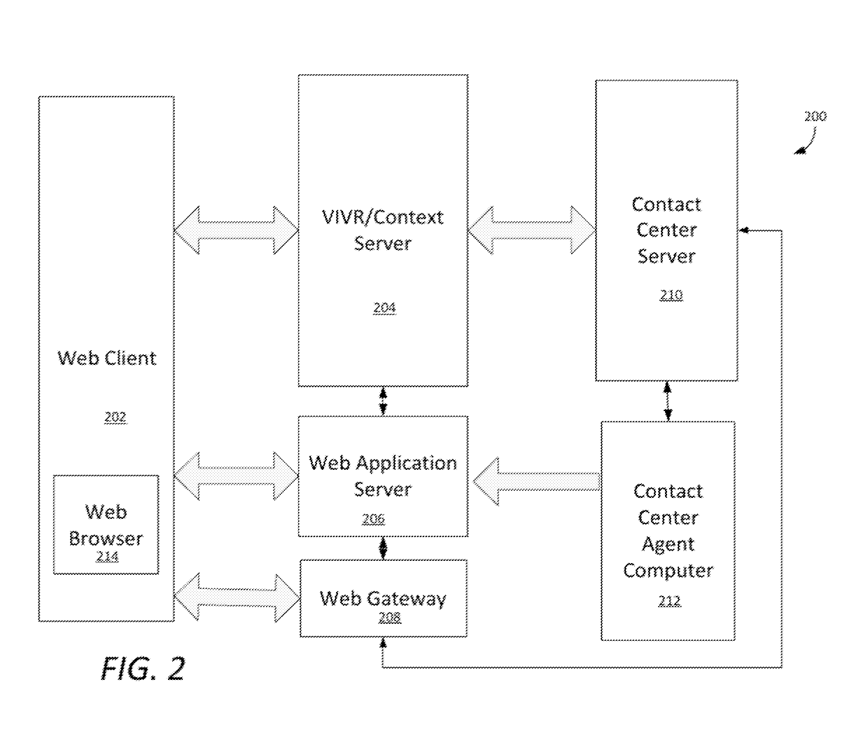

FIG. 2 is a drawing that is useful for understanding a computer system architecture which facilitates managing and sharing of data and media as between mobile/web applications and a corporate contact center. Those skilled in the art will appreciate that the computer system architecture illustrated in FIG. 2 is one possible example of a computer system which can be used for purposes of implementing the inventive arrangements. However, the invention is not limited in this regard and any other suitable computer system architecture can also be used without limitation.

Elements of the system which are shown in FIG. 2 include a web client 202, a VIVR/context server 204, a web application server 206, an SIP web gateway 208, and contact center server 210. Also shown in FIG. 2 is a contact center agent computer 212 which facilitates a contact agent voice/video call with a web client 202 using a communication protocol as described below. The web client 202, contact center server 210 and contact center agent computer 212 can communicate with the VIVR/context server 204, web application server 206 and SIP web gateway 208 over a network such as the Internet or an intranet. Suitable communication paths are also provided as between the web application server 206 and SIP web gateway 208. In some embodiments of the invention, the web application server 206 can reside on the VIVR/context server 204, but the invention is not limited in this regard.

The web client 202 is a client computer system comprised of a combination of hardware and software elements capable of carrying out the functions and operations described herein. The hardware associated with web client 202 can include without limitation a personal computer, a tablet computer, a personal digital assistant and/or a smart-phone. The web client will also include an operating system (not shown) and suitable software, such as a web browser that is capable of communicating HTTP requests to web servers. The web browser 214 will support various web services and standards which are useful for carrying out the functions and operations described herein. For example, the browser provided in web client 202 can support real time communications by means of a supported API such as WebRTC. The web browser can also support user and device authentication, static and dynamic displays associated with web pages, file transfers and so on. As will be appreciated by those skilled in the art, many combinations of hardware and software are possible for purposes of implementing the web client.

The VIVR/context server 204 is a server computer system comprised of a combination of hardware and software for serving web pages, voice data and other information to web clients for purposes of implementing a visual interactive voice response (visual IVR) system. A VIVR session implemented by the VIVR/context server 204 will generally rely on IVR scripts defined by a contact center server (e.g. contact center server 210) for purposes of implementing a visual IVR session. The VIVR/context server will generate and serve one or more web pages to the web client 202 which allow the web client user to visually navigate through an IVR script and more quickly access the information or assistance they require. In order to implement such a visual IVR interaction, the IVR scripts of a particular customer contact center can be accessed in real time by the VIVR/context server 204. Alternatively, the IVR scripts can be preconfigured in the VIVR/context server in advance of a user VIVR session by accessing IVR scripts stored in the contact center server. In either case, the contact center's IVR scripts (which are normally communicated to customers using audible media over telephony (and responded to by customers using DTMF tones) are instead used by the VIVR/context server to facilitate a visual IVR session delivered through a series of web pages. As a result of this interactive session, the VIVR/context server 204 will provide information or resources as requested by a web client user. Alternatively, during the course of the VIVR session, the VIVR/context server may respond to a user request to speak to a live operator or agent at a customer contact center 210.

During the VIVR session, a user can navigate through one or more web pages (e.g., using a web browser) served by the VIVR/context server, and may input data as necessary. More particularly, the user can input data into a web client device 202 and such data will be communicated to the VIVR/context server 204 during the interactive VIVR session. Alternatively, a user can interact with a mobile application executing on the mobile web client device 202. In that case, the VIVR/context server 204 can facilitate an interactive session with the user which is facilitated using the mobile application rather than the browser. For convenience, the invention shall be described in the context of a browser scenario, but it should be understood that the same concepts can be extended for use with other types of mobile device web applications.

Those skilled in the art will appreciate that the VIVR/context server 204 can receive HTTP requests from the web client 202 and translates received URL requests to identify specific web pages which are to be served to the web client. The VIVR/context server 204 can also support various web services and standards which are useful for carrying out the functions described herein. For example, the web server can support authentication of web clients, file transfer and so on. Further, the VIVR/context server can communicate with a contact center server 210 for requesting and receiving data (e.g. data concerning IVR scripts) for purposes as will be hereinafter described.

Web application server 206 executes a web software application which can be accessed by web clients 202 and contact center agent computers 212 for carrying out the visual IVR methods described herein. The web application server 206 is accessed by web clients and the contact center using suitable network communications methods. The web application server 206 can serve web pages to web client 202. For example, the web application server 206 can receive HTTP requests from the web client 202 and can translate received URL requests to identify specific web pages which are to be served to the web client. The web application server 206 can also support various web services and standards which are useful for carrying out the functions described herein. For example, the web application server can support authentication of web clients, file transfer and so on.

The web application server 206 can be configured to facilitate a customer interaction, such as user self-help session. In such a session, the web application server can serve suitable web pages to the web client for the interactive session. The user can navigate through one or more web pages (e.g., using a web browser) and input data as necessary during the interactive session. More particularly, the user can input data into a web client device and such data will be communicated to the web application server 206 during the interactive session. Alternatively, a user can interact with a mobile application executing on the mobile web client device. In that case, the web application server can facilitate an interactive session with the user which is facilitated using the mobile application rather than the browser.

SIP Web gateway 208 is comprised of hardware and/or software that normalizes the signalling between SIP-based devices and WebRTC-based applications so the two can communicate together seamlessly. Accordingly, the SIP web gateway 208 facilitates the initiation of a communication session (such as a voice call or video call) as between the web client 202 and the contact center 210. In this regard it will be appreciated that the contact center 210 can be an SIP type contact center that utilizes the widely known Session Initiation Protocol (SIP) for controlling and implementing voice and/or video calls with a web client through SIP web gateway 208.

As noted above, the web browser 214 (or mobile web application) can support real time communications by means of a suitable API such as WebRTC. A WebRTC enabled browser allows users to initiate both voice and video communications between web browsers with no additional client or plug-in required. Alternatively, the web browser could offer a “click to call” capability that allows the user to utilise a smart-phone or land-line phone as depicted by items 106 and 108 in FIG. 1.

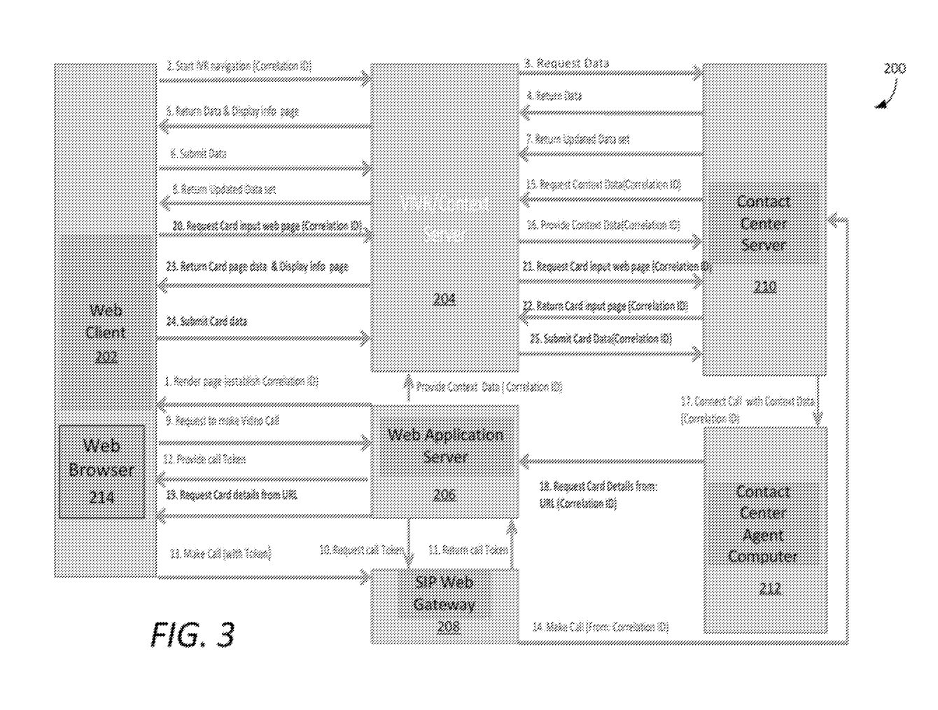

Referring now to FIG. 3, there is shown a flow diagram that is useful for understanding a method for pushing web and application pages to a web client during video/audio calls. The process can begin at step 1 when the web application server 206 serves or renders a web page to the web client 202. For example, the web page can be served in response to a user navigating a web browser to a web address associated with the host contact center. When the web page is rendered to the web client, a correlation ID value is established for the session. For example, the web application server 206 can determine and assign the correlation ID value. The correlation ID value can be generated by any suitable method provided that the value is capable of uniquely identifying the communication session with the host system 200 relative to all other communication sessions established by other web clients with such host system. As an example, the correlation ID value can comprise a numeric or alpha-numeric value. Thereafter, such correlation ID will be known to the web application server 206 and the web client. The correlation ID is stored in a suitable memory location by each of the web application server and the web client to facilitate additional functions as hereinafter described.

Following step 1, the user can continue engaging in an interactive communication session with the web client server. Such a session will generally involve the web application server 206 executing certain scripts and programming logic which will cause the web application server to serve one or more web pages to the web client 202. As part of this process, the user may provide one or more user inputs and/or data at the web client 202 and these inputs can be communicated to the web application server 206. User inputs and other information pertaining to the session may be stored in memory at the web application server together with information specifying the correlation ID for the session. For example, during the communication session, the user may enter personal identification information, purchase preferences, language preferences, and so on.

At some point in the communication session with the web application server 206, after the correlation ID has been established for the session, the customer or user will request in step 2 an IVR navigation session with VIVR/context server 204. The request communicated to the VIVR/context server 204 will specify the previously assigned correlation ID, which information can be stored by the VIVR/context server in a suitable location. As a result of the request in step 2, the VIVR/context server 204 will begin a VIVR navigation session.

Throughout a communication session as described herein, the correlation ID value can be used as a mechanism to identify a particular session and allow each component of the host system to have improved knowledge of a context of each call. The following steps are useful for understanding one exemplary way in which the correlation ID value could be used in a host system 200 as described herein. However, it should be appreciated that a correlation ID value can be used in many ways and the invention is not limited to the particular use cases which are described below.

During the navigation session, the web client 202 may request data (e.g. VIVR script information data) from the contact center server 210. This action is shown as step 3 in FIG. 3. In response to the data request, the contact center server will communicate return data to the VIVR/context server as shown in step 4. The VIVR/context server will then render a suitable VIVR information web page to the web client in step 5, including any data provided by the contact center server. The VIVR navigation session can continue in step 6, where the user enters certain data (e.g. authentication data) and the web client 202 communicates such data to VIVR/context server 204. During the navigation session, the contact center server may return additional updated data (e.g. additional data for implementing a visual IVR script) to the VIVR/context server and this data will be communicated to the web client 202 as part of the visual IVR session as shown in step 8. This interactive process can continue during the communication session as the user interacts with the VIVR/context server 204 to obtain particular host services that are desired.

At a certain point in the VIVR navigation session, the customer or user may decide that they need to speak directly with a human contact center agent. At this point, the customer or user can interact with the web client 202 to indicate their desire to initiate a communication session. The communication session could be a voice call or a video call, but for purposes of this discussion it shall be assumed that a video call is desired. The web client will then communicate in step 9 to the web application server 206 to request set-up of the video call. However, it should be noted that during the course of the communication session with VIVR/context server 204 and web application server 206 a significant amount of context information is often collected. This information can range from the identity of the person calling, their reasons for their call, their purchase interests, their preferred language, and so on. This information can be useful in subsequent communication sessions with other end points in the host enterprise. As noted below, such information can subsequently be accessed by other host system end points using the correlation ID.

In order to initiate the call to a contact center, the web application server 206 will in step 10 request a call token from the SIP web gateway 208. The SIP web gateway will respond in step 11 by returning a call token to the web application server. The call token provided will be a suitable data element (e.g. an alpha-numeric data element) which is required for placing a call through the SIP web gateway 208. In step 12, the web application server 206 will communicate the call token to the web client 202, which will in turn use the call token to initiate a video call in step 13. In step 13, the web browser will communicate the token to the SIP web gateway as part of the call initiation process. Thereafter, in step 14, the SIP web gateway 208 sets up the video call with the contact center server 210. The signalling involved with setting up the call will include a communication to the contact center server of the previously assigned correlation ID. In step 17, the contact center server will complete the call setup and establish a video connection between the web application server 206 and the contact center agent computer 212. As part of this set-up process, the contact center server 210 will provide the contact center agent computer 212 with the correlation ID.

At this point in the process, the contact agent can participate in a video communication session with the user of the web client device. However, during the call, the agent can use the correlation ID at any time to invoke existing enterprise IVR scripts and use those scripts in a visual manner during, rather than prior to, a call. In particular, the contact agent can use his computer to identify to the VIVR/context server a particular web page which is to be served to the web client. The particular web client to which the page is to be served is identified to the VIVR/context server by including the correlation ID value in any such request. Similarly, data input and other responses received by the VIVR/context server from the web client can be communicated to the contact center agent. The particular contact center agent associated with particular data or responses can be specified by the correlation ID value which has been assigned.

As an example, consider that the customer using the web client 202 may at some point need to confirm his identity or provide confidential information such as payment details. Rather than having the agent ask for that information over the phone, the agent can use software executing on the contact center agent computer 212 to trigger a request for the information through a web page. More particularly, in step 18 the contact center agent computer can communicate a trigger or request to the web application server 206. The request will include the correlation ID and will cause the web application server to communicate with the web client in step 19. The communication to the web client in step 19 can include an indication of the information that is needed and/or a reference to a particular URL associated with the VIVR/context server 204.

In step 20, the web client 202 will use the URL information to request from VIVR/context server 204 a web page that will facilitate input of the information (e.g. credit card information) desired by the contact center agent. The request directed to the VIVR/context server will include the correlation ID. The VIVR/context server will then request in step 21 a suitable web page (e.g. a credit card data input web page) from the contact center server. This request will also include the correlation ID. The contact center server will use the correlation ID to generate such web page and will communicate the web page data (and the correlation ID) to the VIVR/context server in step 22. The VIVR/context server will then serve the web page (e.g. credit card page data and information) to the web client in step 23. The user can enter the needed confidential data at the web client 202 and such data can be communicated to the VIVR/context server in step 24. Finally, in step 25, the confidential data is submitted from the VIVR/context server 204 to the contact center server 210. In step 25, the correlation ID is again included so that the contact center server can deliver the new information to the correct agent.

Steps 1-25 described above are useful for understanding how a common session identifier can be used in the inventive arrangements. However, it should be understood that the invention is not limited to the particular scenario which has been described. Instead, the common session identifier can be used in any scenario where (1) it is desirable to push web and application pages to a particular web client while such web client is actively participating in a voice or video call or (2) where a user initiates the video/audio aspects of the call from the web page but the call itself is delivered through the traditional telephony infrastructure (e.g., where the web browser offers a “click to call” capability that allows the user to utilize a smart-phone or land-line phone as depicted by items 106 and 108 in FIG. 1).

For example, consider the scenario above where a customer has initiated a video call as previously described. Assume that the customer is uncertain with regard to the particular type of information required or the way it should be entered into a web page form which has been pushed to the client using the methods described herein. In such a scenario, the customer can in the course of the video call ask the agent for additional help. The agent can then annotate a sample document (e.g. to highlight or mark the location of certain information in web form). Such data can then be published to the context server as previously described, together with the correlation ID. If the web client has already subscribed to the Agent's data when the call was established the context server will automatically push the annotated sample document to the customer application and the document will be displayed as if a screen had been shared. Those skilled in the art will appreciate that the inventive arrangements facilitate the ability to invoke existing enterprise IVR scripts and use those scripts in a visual manner during rather than prior to a call being connected and extending this mechanism to invoke any new trigger.

The present invention can take the form of a computer program product on a computer-readable storage medium (for example, a hard disk or a CD-ROM). The computer-readable storage medium can have computer-usable program code embodied in the medium. The term computer program product, as used herein, refers to a device comprised of all the features enabling the implementation of the methods described herein. Computer program, software application, computer software routine, and/or other variants of these terms, in the present context, mean any expression, in any language, code, or notation, of a set of instructions intended to cause a system having an information processing capability to perform a particular function either directly or after either or both of the following: a) conversion to another language, code, or notation; or b) reproduction in a different material form.

The term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing or encoding a set of instructions for execution by the machine and that cause the machine to perform any one or more of the methodologies of the present disclosure.

The term “computer-readable medium” shall accordingly be taken to include, but not be limited to, solid-state memories such as a memory card or other package that houses one or more read-only (non-volatile) memories, random access memories, or other re-writable (volatile) memories; magneto-optical or optical mediums such as a disk or tape. Accordingly, the disclosure is considered to include any one or more of a computer-readable medium as listed herein and to include recognized equivalents and successor media, in which the software implementations herein are stored.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

1. A method for pushing web pages to a web client during an IVR navigation session, comprising:
assigning a correlation ID to a web client to which a web page is served;
communicating the correlation ID to a VIVR web server and/or a web application server and serving at least a first web page to the web client with the VIVR web server computer or the web application server;
receiving at the VIVR web server or the web application server first data entered at the web client responsive to the first web page;
initiating an IVR navigation session between the web client and a contact center server responsive to a request from the web client; and
during the IVR navigation session, generating at the contact center server at least one command which causes the VIVR web server or the web application server to serve at least a second web page to the web client, wherein said web client to be served is identified to the VIVR web server or the web application server by the contact center server using the correlation ID.

2. The method according to claim 1 further comprising:
receiving at the VIVR web server or web application server second data entered at the web client responsive to the second web page; and
providing the second data to the contact center server, wherein the correlation ID is used to identify the particular web client communication session to which the second data pertains.

3. The method according to claim 1 wherein the VIVR web server is configured to serve web pages based on IVR scripts defined by or stored on the contact center server.

4. The method according to claim 3 wherein the IVR scripts are available in real time.

5. The method according to claim 1 further comprising the step of initiating a voice/video call between the web client and a contact center agent computer associated with the contact center server responsive to a request from the web client; wherein, as part of said initiating, the correlation ID is communicated to the contact center agent computer.

6. The method according to claim 5 wherein the first data and other data received and associated with the correlation ID is communicated to the contact center agent computer.

7. The method according to claim 5 wherein an SIP web gateway is utilized to initiate the voice/video call between the web client and the contact agent computer.

8. The method according to claim 5 further comprising, during the voice/video call, generating at the contact center server at least one command which causes the VIVR web server or the web application server to serve at least a third web page to the web client, wherein said web client to be served is identified to the VIVR web server or the web application server by the contact center server using the correlation ID.

9. An IVR navigation system comprising:
a web application server configured to exchange data with a web client and to serve at least a first web page to the web client such that a correlation ID is associated with the web client;
a VIVR web server configured to exchange data with a web client and to serve at least one IVR web page to the web client based on an IVR script;
a contact center server in communication with the web application server and the VIVR web server;
wherein the IVR navigation system is configured to initiate an IVR navigation session between the web client and the contact center server responsive to a request from the web client and to associate the IVR navigation session with the correlation ID; and during the IVR navigation session, generate at the contact center server at least one command which causes the VIVR web server or the web application server to serve at least a second web page to the web client, wherein said web client to be served is identified to the VIVR web server or the web application server by the contact center server using the correlation ID.

10. The system according to claim 9 wherein the IVR navigation system is further configured to receive at the VIVR web server or web application server second data entered at the web client responsive to the second web page; and provide the second data to the contact center server, wherein the correlation ID is used to identify the particular web client communication session to which the second data pertains.

11. The system according to claim 9 wherein the VIVR web server is configured to serve web pages based on IVR scripts defined by or stored on the contact center server.

12. The system according to claim 9 wherein the IVR navigation system is further configured to initiate a voice/video call between the web client and a contact center agent computer associated with the contact center server responsive to a request from the web client;
wherein, as part of said initiating, the correlation ID is communicated to the contact center agent computer.

13. The system according to claim 12 further comprising an SIP web gateway configured to initiate the voice/video call between the web client and the contact agent computer.

14. The system according to claim 12 wherein the IVR navigation system is further configured to generate, during the voice/video call, at least one command at the contact center which causes the VIVR web server or the web application server to serve at least a third web page to the web client, wherein said web client to be served is identified to the VIVR web server or the web application server by the contact center server using the correlation ID.

15. The system according to claim 9 wherein the IVR navigation system is configured to store data received from the web client and associate said data with the correlation ID.

16. The system according to claim 9 wherein the web application server resides on the VIVR web server.

17. The system according to claim 9 wherein the web application server, the VIVR web server and the contact center server communicate with one another over a network.

18. The system according to claim 17 wherein the network is an internet or an intranet.

19. The system according to claim 9 wherein the web client includes a personal computer, a tablet computer, a personal digital assistant or a smart-phone.

20. The system according to claim 9 wherein the correlation ID is a numeric or alpha-numeric value.
